(19) United States
(12) Patent Application Publication
(10) Pub. No.: US 2013/0200309 A1
(43) Pub. Date: Aug. 8, 2013

(54) NANOCOMPOSITE MATERIAL CONTAINING GLASS FIBER COATED WITH CARBON NANOTUBES AND GRAPHITE AND A METHOD OF PREPARING THE SAME

(71) Applicants: Kyong Hwa SONG, Seoul (KR); Jin Woo KWAK, Suwon (KR); Byung Sam CHOI, Gunpo (KR)

(72) Inventors: Kyong Hwa SONG, Seoul (KR); Jin Woo KWAK, Suwon (KR); Byung Sam CHOI, Gunpo (KR)

(73) Assignee: Hyundai Motor Company, Seoul (KR)

(21) Appl. No.: 13/444,074

(22) Filed: Apr. 11, 2012

(30) Foreign Application Priority Data
Feb. 7, 2012 (KR) 10-2012-0012483

(51) Int. Cl. H01B 1/04; B05D 5/12; B82Y 30/00; B82Y 40/00

(52) U.S. Cl. 252/502; 427/122; 977/742; 977/750; 977/752; 977/890

(57) ABSTRACT

The present disclosure relates to a nanocomposite material containing carbon nanotube coated glass fiber and graphite, in which fiber-shaped conductive particles obtained by coating a glass fiber with carbon nanotube as a conductive material with a good electromagnetic wave shielding property are hybridized with graphite sheets having a nanometer thickness and having an excellent heat conductivity, thereby creating a nanocomposite material with excellent electromagnetic wave shielding and heat dissipation properties. The nanocomposite material may be applied to a wide variety of electronics fields requiring both electromagnetic wave shielding and heat dissipation property, such as automotive electronic component housings, components of an electric car, mobile phones, and display devices.

### CROSS-REFERENCE TO RELATED APPLICATION

This application claims under 35 U.S.C. §119(a) the benefit of Korean Patent Application No. 10-2012-0012483 filed on Feb. 7, 2012, the entire contents of which are incorporated herein by reference.

### BACKGROUND

(a) Technical Field

The present invention relates to a functional nanocomposite material including carbon nanotube coated glass fiber and graphite for use in a variety of electronic applications, and a method of making the same. More particularly, the present invention relates to a functional nanocomposite material in which fiber-shaped conductive particles are obtained by coating a glass fiber with carbon nanotube and then hybridized with graphite sheets having a nanometer thickness, thereby producing a nanocomposite material with excellent electrical conductivity, electromagnetic wave shielding, and heat conductivity properties, and a method of making the same.

(b) Background Art

It is known that electromagnetic waves represent a serious threat to the development of a variety of technologies such as, for example, information and communication technologies, computer technologies, automotive technologies, and the like.

For example, the malfunction of a radio communication apparatus by the generation of unnecessary electromagnetic waves may cause a serious danger to both the safety of the electronic devices themselves, and the safety and the people who depend on the communication apparatus. As another example, electromagnetic waves have become an increasing problem in automotive applications as a result of interference between components caused by the rapid increase in the use of electronic devices, and noise created by the use of high frequencies, which may affect the function of a variety of other components in the vehicle, thereby causing a vehicle accident. Accordingly, electromagnetic wave shielding is very important for a variety of applications.

Additionally, the production of heat also represents a serious problem for many electronics applications because the operation of electronic components generates heat, which directly affects the durability of the product. As a result, heat control is an important issue for many electronic applications. This is especially true in the case of a car, which generates a large amount of heat during operation.

Most housings generally used in electronic components are made of metal material, so there is no particular problem in the electromagnetic wave shielding; additionally, metal material has a high heat conductivity, so that it is generally possible to control the heat transmission from the component. In the case of a product made of a plastic material, the problem of the electromagnetic wave has typically been solved by coating the plastic or plating the plastic with a conductive material by an electroless method to provide electromagnetic wave shielding. Disadvantageously, the attachment/removal of the coated paint and the use of an electrolysis solution in the above process cause significant environment problems. Furthermore, with respect to the problem of heat dissipation, a heat conductive material must be used separately in addition to the conductive material of the electromagnetic wave shielding. For example, a metal is additionally attached to one surface of the plastic. However, as a result of the expansion of the use of electronic devices in cars and the rapid supply of mobile displays, there has been an increased demand for plastic electronic components in order to meet the design demands for compact electronic components. Accordingly, there has been a continuous demand to replace metal electronic components with plastic electronic components because plastic is light and easily fabricated into various shapes. Consequently, the number of components made of the plastic is expected to increase substantially in the future. Unfortunately, this trend faces a serious problem: plastic does not have the conductivity of metal, so it is impossible to use plastic for a housing material for an electronic component that requires electromagnetic wave shielding.

In order to solve the drawbacks of plastic, research has focused on preparing a composite by adding a filler having excellent conductivity. For example, the electromagnetic wave shielding of a plastic composite may be produced by a method of dispersing at least 30 vol % of a metal powder having excellent electrical conductivity throughout the plastic, or by using carbon fibers in a polymer, such as silicon rubber, polyurethane, polycarbonate, and epoxy resin. In this case, it is known that the use of silver powder or silver coated copper (Ag-coated Cu) as the metal powder has the best electrical conductivity, and when a content of approximately 30 vol % of silver powder is dispersed in the polymer, it is possible to obtain a volume resistivity of 0.01 Ω-cm or less and achieve a shielding effect of approximately 50 dB.

In order to comply with the electromagnetic wave shielding standards, which have recently become quite strict, it is now necessary to achieve a lower volume resistivity and a high shielding effect. To this end, it is necessary to disperse a larger quantity of metal powder, such as silver powder, in the polymer. However, when such a large quantity of silver powder is dispersed in the polymer, the electromagnetic wave shielding effect may be improved by the improvement of the electrical conductivity, however, the mechanical properties of the material, such as impact strength, is degraded. Consequently, there are many significant limitations in the application of a metal powder as an electromagnetic wave shielding material.

As an alternative, it has been suggested that a carbon nanotube may be used as an electromagnetic wave shielding material. Carbon nanotube is a material having a shape of an elongated tube made of carbon atoms and having a nano diameter, an electrical conductivity 1000 times higher than that of copper, a high strength and modulus of elasticity corresponding to 100 times that of steel, and a high aspect ratio of a length to a diameter. Accordingly, the polymer composite, in which the carbon nanotube is dispersed in a polymer matrix, has been noted in one aspect as being capable of being used as a functional material, such as a material having a high strength relative to its weight, a conductive material, and an electromagnetic wave shielding material. In a case of using the aforementioned carbon nanotube, although there is a slight difference of the volume ratio depending on the type of polymer matrix, even if at least 0.04 vol % of the carbon nanotube is dispersed, a conductive network may be formed to achieve a low volume resistivity. However large the content of carbon nanotube may be, the carbon nanotube shows high volume electric resistivity of a minimal 10 Ω-cm when only the carbon nanotube is mixed with the polymer, so that it fails to achieve the electromagnetic wave shielding effect, and it is difficult to disperse the carbon nanotube throughout the polymer. As a result, the carbon nanotube is limited to being applied to a complex material, such as a material for the electromagnetic wave shielding.

In order to solve this limitation, a plurality of patent applications using various mixing fillers for adding metal powders in order to increase the conductivity of the carbon nanotube have been previously filed. For example, Korean Patent Application Publication No. 2010-0080419 suggests a resin composition which contains a fiber filler, such as thermoplastic resin and glass fiber and a carbon-based filler, such as carbon nanotube, and is usable for the high performance electromagnetic wave interference shielding. However, the glass fiber is not a glass fiber coated with the carbon nanotube and does not contain graphite, so there is no difference in the material characteristic.

Furthermore, Korean Patent Application Publication No. 2010-0058342 suggests plastic moldings fabricated of a conductive resin composition containing a carbon compound of a thermoplastic resin, a surface-reformed carbon nanotube, and graphite to shield the electromagnetic waves. In addition, most of the patent applications focus on the improvement of the conductivity so as to increase the electromagnetic wave shielding property.

Unfortunately, these proposed solutions are disadvantageous because they fail to address the issue of heat dissipation. According to a principle mechanism of shielding of an electromagnetic wave in a polymer containing a conductive filler, when the electromagnetic wave meets a new medium surface while being transferred through air, some electromagnetic waves are reflected and the remaining electromagnetic waves are bent and transmitted. In this event, when the electromagnetic waves meet a conductive nano material inside the new medium, multi-reflection or absorption of the electromagnetic waves is created, so that the electromagnetic waves are weakly changed or dissipated, or some of the electromagnetic waves are transmitted. In other words, a large portion of the electromagnetic waves dissipate while being reflected and absorbed by an interior filler in the polymer composite. The absorbed electromagnetic waves are changed to heat, which is gradually discharged from the component while moving along a network of the filler. Accordingly, in order to shield the electromagnetic waves, the composite should ultimately contain both a material with a good electrical conductivity and a material with a good heat transfer. However, the solutions proposed above fail to provide such materials. Accordingly, there is a need in the art to develop composite materials that have excellent electrical conductivity and heat transfer/dissipation properties.

### SUMMARY OF THE DISCLOSURE

In order to solve the aforementioned problems of the prior art, research on a method of further maximizing an electromagnetic wave shielding performance through efficiently transferring heat generated from absorbed electromagnetic waves was conducted. The present invention is based, at least in part, on the discovery that a glass fiber coated with a carbon nanotube not only has an excellent conductivity and readily facilitates the transfer of heat, but also maintains the property of a polymer, and simultaneously serves as a competitive filler enabling graphite with a micro size to be easily dispersed. Accordingly, an aspect of the present invention is to provide a functional nanocomposite in which a glass fiber coated with a carbon nanotube is hybridized with graphite having a nano thickness.

Accordingly, an aspect of the present invention is to provide a functional nanocomposite material that has the properties of a polymer, while simultaneously providing excellent electromagnetic wave shielding and heat conduction properties.

In one aspect, the present invention provides a functional nanocomposite material prepared by hybridizing a carbon nanotube coated glass fiber with graphite having a nanometer thickness.

In another aspect, the present invention provides a method of preparing a functional nanocomposite material, including: preparing a carbon nanotube coating solution; coating a glass fiber with the carbon nanotube coating solution; compounding the glass fiber with graphite and a matrix polymer to prepare a compounded mixture; and preparing a nanocomposite by hybridizing the compounded mixture by using a compression mold.

According to the present invention, it is possible to prepare a functional nanocomposite material that induces the effective dispersion within the matrix resin and the simultaneous formation of the network by coating the glass fiber with the carbon nanotube, and improves the electromagnetic wave shielding performance by simultaneously adding graphite having excellent heat conductivity, thereby improving the electromagnetic wave shielding property, the heat dissipation property, and the mechanical strength of the material.

Furthermore, the nanocomposite material according to the present invention achieves the dispersion of the nano filler and provides the functionality to the polymer, and as a result, the present invention can be applied to various fields, such as, for example, a housing of an electric control unit (ECU) of a car, a component of an electric car, and a housing of a mobile phone and a display device.

### BRIEF DESCRIPTION OF THE DRAWINGS

The above and other features of the present invention will now be described in detail with reference to certain exemplary embodiments thereof illustrated in the accompanying drawings which are given herein below by way of illustration only, and thus are not limitative of the present invention, and wherein:

FIG. 1 is a graph illustrating a measurement result of electromagnetic wave shielding of composites prepared in an embodiment of the invention relative to a comparative example.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that the present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Ranges provided herein are understood to be shorthand for all of the values within the range. For example, a range of 1 to 50 is understood to include any number, combination of numbers, or sub-range from the group consisting of 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50, as well as all intervening decimal values between the aforementioned integers such as, for example, 1.1, 1.2, 1.3, 1.4, 1.5, 1.6, 1.7, 1.8, and 1.9. With respect to sub-ranges, “nested sub-ranges” that extend from either end point of the range are specifically contemplated. For example, a nested sub-range of an exemplary range of 1 to 50 may comprise 1 to 10, 1 to 20, 1 to 30, and 1 to 40 in one direction, or 50 to 40, 50 to 30, 50 to 20, and 50 to 10 in the other direction.

In one aspect, the present invention is characterized by a functional nanocomposite prepared by hybridizing a fiber glass coated with a carbon nanotube with graphite having a nano thickness.

In an exemplary embodiment, the carbon nanotube may be selected from the group consisting of a Single Walled Carbon nanotube (SWNT), a Double Walled Carbon nanotube (DWNT), and a Multi Walled Carbon nanotube (MWNT). In a preferred embodiment, the carbon nanotube is aMWNT. In this case, it is preferable that the carbon nanotube has a diameter ranging from about 20 to about 200 nm and has a length ranging from about 1 to about 200 μm. Carbon nanotubes with a very short diameter and a long length are not preferred because the carbon nanotube is dispersed in a bent shape, which makes it difficult to orient the carbon nanotube lengthwise in a glass fiber after the coating. Carbon nanotubes with a long diameter and a short length are also not preferred because they have a small aspect ratio, which makes it difficult to maintain contact between the fillers.

The glass fiber may use a glass fiber having a diameter ranging from about 5 to about 50 μm, and having a length ranging from about 1 to about 15 mm It is contemplated within the scope of the invention that the cross section may assume any shape, as the shape of the cross section does not affect the contact surface with a counterpart filler and/or improve a dispersion effect. However, it is preferable that a size of a shorter side of the glass fiber is identical to or smaller than a size of graphite in comparison to the size of the glass fiber and the size of graphite to be mixed. Further, it is preferable that a quantity of the carbon nanotube coated on the glass fiber ranges from about 0.1 to about 10 wt %. Since the carbon nanotube has difficulty in being dispersed within the polymer, the quantity of the carbon nanotube required for forming a network is increased, so that the carbon nanotube is coated on the glass fiber. In order to solve the problem, the carbon nanotube may be easily dispersed and easily form the network by fabricating a conductive filler in a micro unit by using carbon nanotube coated on the glass fiber.

Graphite formed into a sheet having a pre-determined nanometer thickness is a material that has excellent heat transfer properties when graphene having a heat transfer value of 200 to 300 W/mK is disposed in a thickness of four to seven layers.

In some exemplary embodiments, the graphite may have a thickness of 10 to 100 nm and a length of 5 to 50 μm. In this case, when the graphite has a thickness smaller than 10 nm, it creates a large processing expense for the separation from the graphite powder, and when the graphite has a thickness larger than 100 nm, the graphite weight ratio disadvantageously increases without an increase in the heat transfer properties. Further, when the graphite has a length shorter than 5 μm, the length of the filler for the heat transfer is short, so that the graphite begins to have a size smaller than the diameter of the glass fiber; additionally, the conductivity is decreased, thereby decreasing the dispersion effect.

The present invention prepares a functional nanocomposite material by a method including the steps of: preparing a carbon nanotube coating solution; coating a glass fiber with the carbon nanotube coating solution; compounding graphite and matrix polymer with the glass fiber prepared in the previous step to prepare a mixture; and preparing the compounded mixture into a hybridized nanocomposite by using a compression mold.

In some exemplary embodiments, the quantity of added carbon nanotube is 0.1 to 20 wt %, which is a smaller quantity of the carbon nanotube than is generally used. This simultaneously provides electromagnetic wave shielding properties and heat dissipation properties. If the quantity of added carbon nanotube is less than 0.1 wt %, it is difficult to expect the improvement of the shielding property by the addition of the carbon nanotube. In contrast, if the quantity of added carbon nanotube is greater than 20 wt %, the volume of the added carbon nanotube increases, so that the carbon nanotube is saturated on the entire surface of the polymer matrix and cannot be effectively coated on the fiber glass.

In an exemplary embodiment, the step of coating the glass fiber with the carbon nanotube coating solution includes preparing the carbon nanotube coating solution by activating a surface of the MWNT with microwaves, and then putting the surface-activated MWNT into a solvent and dispersing the carbon nanotube throughout by performing a general ultrasonication. The dispersion solvent may be a solvent having a low boiling point, such as an alcohol including, but not limited to, ethanol, propanol, and buthanol, and acetone, so as to be easily dried. In a preferred embodiment, the carbon nanotube coating solution has a surface coating quantity of 0.1 to 10 wt %. The dispersant may be a dispersant capable of being removed through a post-processing step, such as, for example, sodium dodecyl sulfate (SDS), sodium dodecylbenzenesulfonate (SDBS), cetrimonium bromide (CTAB), or the like. Furthermore, in order to improve the attachment of the carbon nanotube to the glass fiber, a small quantity of a binder may be added to the solution for use.

Further, in the step of compounding the carbon nanotube coated glass fiber, graphite, and the matrix polymer to prepare the mixture, the carbon nanotube coated glass fiber and the graphite are preferably mixed in a volume ratio of 4:6 to 1:9 (e.g., a ration range including 4:6, 3:7, 2:8, 1:9, as well as all intermediate ratio values). In a preferred embodiment, the graphite sheets are mixed with the glass fiber and the glass fibers are overlapped between the graphite sheets to achieve formation of the entire network between the fillers. Further, the quantity of the carbon nanotube may be increased relative to the graphite to maintain the basic electromagnetic wave shielding properties and the heat dissipation properties by serving the function of removing the heat generated due to the electromagnetic wave shielding. Nevertheless, the compounding ratio may be determined and/or varied according to the type of component to which it is to be applied, and the desired electromagnetic wave shielding and heat transfer properties.

The matrix polymer uses a thermoplastic resin, and the thermoplastic resin may be selected from, but is not limited to, the group consisting of polyethylene, polypropylene, polystyrene, polyalkylene terephthalate, polyamide resin, a polyacetal resin, polycarbonate, polysulfone, polyimide, and a mixture thereof. The thermoplastic resin (i.e., a crystallizable thermoplastic resin) occupies a crystalline area of the polymer during crystallization to push the filler out of the crystalline area, thereby forming a conductive passageway as compared to a non-crystalline resin.

In the compounding of the graphite having a nanometer thickness, the matrix polymer, and the carbon nanotube coated glass fiber, a melting and mixing temperature may be varied depending on the type of thermoplastic resin used. In a preferred embodiment, the compounded mixture has a melting and mixing temperature ranging from 180° C. to 300° C. If the melting and mixing temperature is lower than 180° C., the matrix polymer is not sufficiently melted so the filler may not be regularly mixed. In contrast, if the melting and mixing temperature is higher than 300° C., strand break of the polymer is accelerated, thereby causing degradation of the mechanical properties of the functional nanocomposite.

The nanocomposite obtained by hybridizing the compounded mixture by using a compression mold may contain various additional additives, including, but not limited to, an antioxidant, a colorant, a mold release, and a light stabilizer. Additionally, the quantity of the additive used may be appropriately controlled and applied according to various factors including the intended final use and the desired properties. According to an aspect of the invention, it is possible to produce a carbon nanotube molded product having excellent electromagnetic wave shielding properties even with a small content of carbon nanoparticles by using the composite of the carbon nanotube with the improved dispersion, and improve the shielding properties by simultaneously mixing a graphite material having excellent heat transfer properties. Accordingly, when the nanocomposite material is applied to an electronic component for the heat dissipation function, it is possible to prepare a plastic nanocomposite capable of achieving the effect of the electromagnetic wave shielding and heat dissipation.

Hereinafter, the present invention will be described based on an exemplary embodiment in more detail, but the present invention is not limited to the exemplary embodiment.

### EXAMPLE

### Preparation of a Hybrid Composite of Carbon Nanotube and Graphite

A glass fiber was coated with a carbon nanotube to prepare a conductive particle in a fiber shape of a micro unit through a following method. The glass fiber was impregnated in a carbon nanotube dispersion solution for about 0.5 to about 5 minutes, depending on the desired thickness, taken out of the carbon nanotube dispersion solution, and dried in an oven for use. The drying temperature was equal to or higher than the boiling point of the solvent used, and the glass fiber was sufficiently dried for at least about 60 minutes.

The glass fiber coated with 5 wt % of the MWNT (with a diameter of 80 nm and a length of 100 μm) and the graphite (with an average thickness of 40 nm and a size of 20 μm) were prepared in a volume ratio of 7:3 such that the resulting compounded mixture contained 8 wt % of the filler based on the total weight of the compounded mixture, and regularly mixed with polypropylene as the thermoplastic polymer using a Haake Extruder mixer at a melting temperature of 230° C. and a speed of 100 rpm. The obtained pallet-type compounding material was prepared as a nanocomposite material having a thickness of 3 mm by using a compression mold.

### COMPARATIVE EXAMPLE

### Preparation of a Carbon Nanotube Composite

Polypropylene was used as the thermoplastic polymer. 20 wt % of the MWNT (with a diameter of 80 nm and a length of 100 μm) was mixed by using a Haake mixer at a melting temperature of 230° C. and a speed of 100 rpm. The obtained pallet-type compounding material was prepared as a nanocomposite material having a thickness of 3 mm by using a compression mold.

### Experimental Example 1

### Result of an Electromagnetic Wave Shielding Property of the Composites Prepared in the Embodiment and the Comparative Example

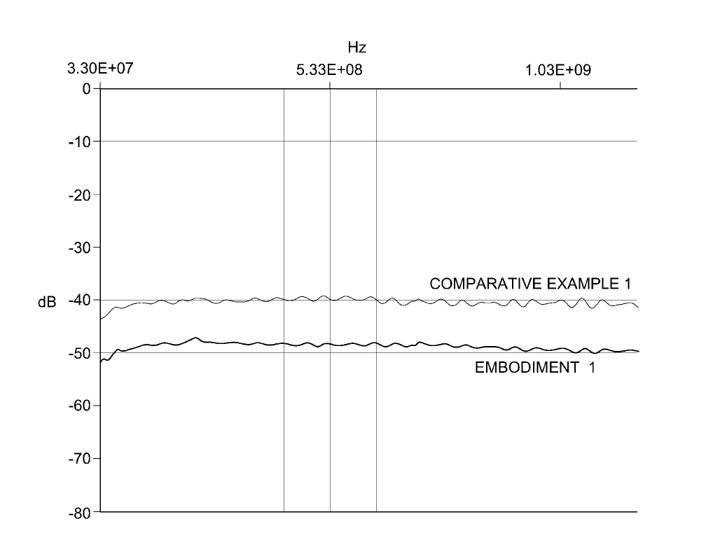

The electromagnetic wave shielding ability of the composite prepared in according to the exemplary embodiment and the comparative example was measured using an electromagnetic wave shielding measuring instrument (E 8362B Aglient). As illustrated in FIG. 1, the electromagnetic wave shielding property of the composite prepared in the embodiment was high compared to the comparative example. It can be appreciated that when the same quantity of fillers are added, the composite prepared by hybridizing the graphite nano particles having excellent heat transfer properties with the carbon nanotube achieved a better electromagnetic wave shielding property than the exclusive carbon nanotube having the excellent electromagnetic wave shielding property. In the case of the comparative example, although the added carbon nanotube was more than double that in the case in which the carbon nanotube was coated on the glass fiber to be added, it was shown that the electromagnetic wave shielding effect was better in the exemplary embodiment of the invention. Accordingly, it can be appreciated that the coating of the nanotube on the glass fiber achieves the improved dispersion effect and generally requires less filler.

### Experimental Example 2

### Result of a Thermal Property of the Composites Prepared in the Embodiment and the Comparative Example

Heat transfer measurement values of the composites prepared in the embodiment and the comparative example were measured using a heat conduction measuring instrument (TCI-2-A, C-Therm Technologies Ltd.) in order to identify the heat transfer/dissipation properties of the tested materials. The measured results are represented in Table 1.

TABLE 1

| | Example: | Comparative Example: |
|---|---|---|
| Test item | 20 wt % CNT/GNP/PP | 20 wt % CNT/PP |
| Heat property (W/mK) | 2.0 | 1.1 |
| Through plane | | |

As shown in Table 1, the heat conductivity was higher in the exemplary embodiment. Accordingly, it can be seen that it is possible to prepare a composite having excellent mechanical properties and electromagnetic wave shielding properties by a method of preparing the functional nanocomposite through coating the carbon nanotube on the glass fiber and mixing the carbon nanotube coated glass fiber with graphite, and the prepared functional nanocomposite may be used in a variety of applications requiring electromagnetic wave shielding and heat conductivity.

What is claimed is:

1. A nanocomposite material comprising a glass fiber coated with a carbon nanotube and a graphite having a predetermined nanometer thickness.

2. The nanocomposite material of claim 1, wherein the carbon nanotube is selected from the group consisting of a single walled carbon nanotube (SWNT), a double walled carbon nanotube (DWNT), and a multi walled carbon nanotube (MWNT).

3. The nanocomposite material of claim 1, wherein the carbon nanotube has a diameter ranging from 20 nm to 200 nm and a length ranging from 1 μm to 200 μm.

4. The nanocomposite material of claim 1, wherein the glass fiber has a diameter ranging from 5 μm to 50 μm and a length ranging from 1 mm to 15 mm

5. The nanocomposite material of claim 1, wherein the glass fiber is coated with 0.1 to 10 wt % of the carbon nanotube.

6. The nanocomposite material of claim 1, wherein the graphite has a predetermined nano thickness ranging from 10 nm to 100 nm and a length ranging from 5 μm to 50 μm.

7. A method of preparing a nanocomposite material, comprising:
preparing a carbon nanotube coating solution;
coating a glass fiber with the carbon nanotube coating solution;
compounding the glass fiber with graphite and a matrix polymer to prepare a compounded mixture; and
hybridizing the compounded mixture with a compression mold, thereby preparing a nanocomposite material.

8. The method according to claim 7, wherein the carbon nanotube coating solution comprises 0.1 to 20 wt % carbon nanotube.

9. The method according to claim 7, wherein the glass fiber is coated with a surface coating quantity of the carbon nanotube coating solution ranging from 0.1 to 10 wt %.

10. The method according to claim 7, wherein the matrix polymer is selected from the group consisting of polyethylene, polypropylene, polystyrene, polyalkylene terephthalate, polyamide resin, polyacetal resin, polycarbonate, polysulfone, polyimide, and any mixture thereof.

11. The method according to claim 7, wherein the graphite and the carbon nanotube coated glass fiber are mixed in a volume ratio of 4:6 to 1:9.

12. The method according to claim 7, wherein the compounded mixture has a melting and mixing temperature ranging from 180° C. to 300° C.
